(19) United States
(12) Patent Application Publication
(10) Pub. No.: US 2021/0103281 A1
(43) Pub. Date: Apr. 8, 2021

(54) INFORMATION PROCESSOR, INFORMATION PROCESSING METHOD, AND PROGRAM

(71) Applicant: SONY CORPORATION, Tokyo (JP)

(72) Inventor: Noriaki TAKAGI, Kanagawa (JP)

(73) Assignee: SONY CORPORATION, Tokyo (JP)

(21) Appl. No.: 16/971,145

(22) PCT Filed: Dec. 20, 2018
(86) PCT No.: PCT/JP2018/047116

§ 371 Date: Aug. 19, 2020

(30) Foreign Application Priority Data
Feb. 26, 2018 (JP) 2018-032416

(51) Int. Cl. G05D 1/00; G05D 1/02; G10L 15/22; A63F 13/21

(52) U.S. Cl. CPC G05D 1/0088; G05D 1/0276; G10L 2015/223; A63F 13/21; G05D 2201/0214; G10L 15/22

(57) ABSTRACT

There is provided an information processor and an information processing method to more naturally and effectively enable communication with a user. The information processor includes a motion controller that controls a motion of an autonomous mobile body, the motion controller causing the autonomous mobile body to perform a transfer motion in a state in which the autonomous mobile body maintains a forward-tilting attitude, the transfer motion including at least any one of a forward and backward movement, a turning movement, or a rotary movement. Further, the information processing method includes controlling a motion of an autonomous mobile body by a processor, the controlling including causing the autonomous mobile body to perform a transfer motion in a state in which the autonomous mobile body maintains a forward-tilting attitude, the transfer motion including at least any one of a forward and backward movement, a turning, or a rotary movement.

### TECHNICAL FIELD

The present disclosure relates to an information processor, an information processing method, and a program.

### BACKGROUND ART

Various devices that respond to an action of a user have recently been widely used. Such devices include an agent that presents an answer to an inquiry from a user, or the like. For example, PTL 1 discloses a technology where an expectation value of attentiveness of a user to outputted information is calculated and information output is controlled on the basis of the expectation value.

### CITATION LIST

### Patent Literature

PTL 1: Japanese Unexamined Patent Application Publication No. 2015-132878

### SUMMARY OF THE INVENTION

### Problems to be Solved by the Invention

Meanwhile, it has been found that a recent agent tends to place more emphasis on communication with a user in addition to simple information presentation. However, a device that responds to an action of a user as described in PTL 1 is unlikely to cause sufficient communication to occur.

Accordingly, the present disclosure proposes an information processor, an information processing method, and a program that are novel and improved, and able to more naturally and effectively enable communication with a user.

### Means for Solving the Problems

According to the present disclosure, an information processor is provided, the information processor including a motion controller that controls a motion of an autonomous mobile body, the motion controller causing the autonomous mobile body to perform a transfer motion in a state in which the autonomous mobile body maintains a forward-tilting attitude, the transfer motion including at least any one of a forward and backward movement, a turning movement, or a rotary movement.

Further, according to the present disclosure, an information processing method is provided, the information processing method including controlling a motion of an autonomous mobile body by a processor, the controlling including causing the autonomous mobile body to perform a transfer motion in a state in which the autonomous mobile body maintains a forward-tilting attitude, the transfer motion including at least any one of a forward and backward movement, a turning movement, or a rotary movement.

Further, according to the present disclosure, a program for causing a computer to function as an information processor is provided, the information processor including a motion controller that controls a motion of an autonomous mobile body, the motion controller causing the autonomous mobile body to perform a transfer motion in a state in which the autonomous mobile body maintains a forward-tilting attitude, the transfer motion including at least any one of a forward and backward movement, a turning movement, or a rotary movement.

### Effects of the Invention

The present disclosure as described above is able to more naturally and effectively enable communication with a user.

It is to be noted that the above-described effect is not necessarily limitative and any effect described herein or any other effect understandable herefrom may be achieved in addition to or instead of the above-described effect.

### BRIEF DESCRIPTION OF DRAWINGS

FIG. 1 is a front view and a back view of an autonomous mobile body according to one embodiment of the present disclosure.

FIG. 2 is a perspective view of the autonomous mobile body according to the embodiment.

FIG. 3 is a side view of the autonomous mobile body according to the embodiment.

FIG. 4 is a top view of the autonomous mobile body according to the embodiment.

FIG. 5 is a bottom view of the autonomous mobile body according to the embodiment.

FIG. 6 is a schematic diagram of assistance in explaining an inner structure of the autonomous mobile body according to the embodiment.

FIG. 7 is a diagram illustrating a configuration of a substrate according to the embodiment.

FIG. 8 is one cross-sectional view of the substrate according to the embodiment.

FIG. 9 is a diagram illustrating a surrounding structure of a wheel according to the embodiment.

FIG. 10 is a diagram illustrating the surrounding structure of the wheel according to the embodiment.

FIG. 11 is a diagram of assistance in explaining a forward-tilting travel of the autonomous mobile body according to the embodiment.

FIG. 12 is a diagram of assistance in explaining the forward-tilting travel of the autonomous mobile body according to the embodiment.

FIG. 13A is a diagram of assistance in explaining an effect achieved by a forward-tilting motion of an autonomous mobile body 10 according to an embodiment.

FIG. 13B is a diagram of assistance in explaining an effect achieved by the forward-tilting motion of the autonomous mobile body 10 according to an embodiment.

FIG. 14 is a block diagram illustrating a configuration example of an information processing system according to the embodiment.

FIG. 15 is a block diagram illustrating a functional configuration example of the autonomous mobile body according to the embodiment.

FIG. 16 is a block diagram illustrating a functional configuration example of an information processing server according to the embodiment.

FIG. 17 is a diagram illustrating an example of an inducing motion for causing a user to perform a predetermined action according to the embodiment.

FIG. 18 is a diagram illustrating an example of an inducing motion for causing a user to perform a predetermined action according to the embodiment.

FIG. 19 is a diagram illustrating an example of an inducing motion for causing a user to perform a predetermined action according to the embodiment.

FIG. 20 is a diagram illustrating an example of an inducing motion for causing a user to perform a predetermined action according to the embodiment.

FIG. 21 is a diagram illustrating an example of an inducing action that induces a collaborative action of a user and the autonomous mobile body according to the embodiment.

FIG. 22 is a diagram illustrating an example of an inducing action that induces a collaborative action of a user and the autonomous mobile body according to the embodiment.

FIG. 23 is a diagram illustrating an example of an inducing action that induces a collaborative action of a user and the autonomous mobile body according to the embodiment.

FIG. 24 is a diagram illustrating an example of an inducing action that induces a collaborative action of a user and the autonomous mobile body according to the embodiment.

FIG. 25 is a diagram of assistance in explaining an inducing motion related to indication of an article position according the embodiment.

FIG. 26 is a diagram of assistance in explaining an inducing motion for inviting a user to sleep according to the embodiment.

FIG. 27 is a diagram of assistance in explaining communication between the autonomous mobile body and another device according to the embodiment.

FIG. 28 is a diagram of assistance in explaining communication between the autonomous mobile body and another device according to the embodiment.

FIG. 29 is a flowchart illustrating a flow of control of the autonomous mobile body 10 by the information processing server according to the embodiment.

FIG. 30 is a flowchart illustrating an example of a flow from a recognition process to a motion control according to the embodiment.

FIG. 31 is a diagram illustrating a hardware configuration example according to one embodiment of the present disclosure.

### MODES FOR CARRYING OUT THE INVENTION

In the following, a preferred embodiment of the present disclosure is described in detail with reference to the attached drawings. It is to be noted that the same reference sign is used to refer to components with substantially the same functional configuration herein and in the drawings to omit a redundant description.

It is to be noted that the description is made in the following order.

### 1. Embodiment

1.1. Overview

1.2. Configuration Example of Autonomous Mobile Body 10

1.3. System Configuration Example

1.4. Functional Configuration Example of Autonomous Mobile Body 10

1.5. Functional Configuration Example of Information Processing Server 20

1.6. Details of Inducing Motions

1.7. Growth Example of Autonomous Mobile Body 10

1.8. Flow of Control

### 2. Hardware Configuration Example

### 3. Summary

### 1. Embodiment

### <<1.1. Overview>>

First, an overview of one embodiment of the present disclosure is described. Various agent devices that perform a responding motion to an action of a user have recently been widely used as described above. The agent devices are each able to perform, for example, various information presentation in accordance with an inquiry from a user. Such information presentation includes, for example, presentation of recommendation information, schedule, news, etc. to the user.

However, in many cases, the agent devices each perform a motion as described above in accordance with an instruction command inputted by the user. Examples of such an instruction command include inputting a keyword by voice, pressing a button for function execution, etc. For this reason, the information presentation by the agent devices as described above is a passive motion and unlikely to activate communication with the user.

Further, the agent devices, some of which have a continuous dialogue with the user by voice or the like, usually merely repeat a passive motion responsive to the instruction command from the user and are unlikely to perform true communication.

A technical idea according to the present disclosure, which has been achieved with a focus on the above-described point of view, is able to more naturally and effectively enable communication with a user. Accordingly, one of features of an autonomous mobile body 10 according to the present embodiment is to actively perform various motions to induce communication with a user (hereinafter, also referred to as inducing motions).

For example, the autonomous mobile body 10 according to the present embodiment is able to actively perform information presentation to a user on the basis of environment recognition. Further, the autonomous mobile body 10, for example, actively performs various inducing motions to encourage a user to perform predetermined actions. In this respect, the autonomous mobile body 10 according to the present embodiment is clearly different from a device that performs a passive motion on the basis of an instruction command.

Further, the inducing motions of the autonomous mobile body 10 according to the present embodiment can be said to be active and positive interference to a physical space. The autonomous mobile body 10 according to the present embodiment is able to move in the physical space, performing various physical motions with respect to a user, a creature, an article, or the like. The above-described features of the autonomous mobile body 10 of the present embodiment allow the user to comprehensively recognize the motion of the autonomous mobile body 10 through the sense of vision, a sense of hearing, a sense of touching, making it possible to enable a high-level communication as compared with, for example, a case where a dialogue with the user is performed simply by voice.

In the following, detailed description is made on the autonomous mobile body 10 according to the present embodiment that implements the above-described features and functions of an information processing server 20 that controls the autonomous mobile body 10.

### <<1.2. Configuration Example of Autonomous Mobile Body 10>>

Next, description is made on a configuration example of the autonomous mobile body 10 according to one embodiment of the present disclosure. The autonomous mobile body 10 according to the present embodiment may be a variety of devices that performs an autonomous motion on the basis of environment recognition. In the following, the description is made, as an example, of a case where the autonomous mobile body 10 according to the present embodiment is a robot in a form of a long ellipsoid that autonomously travels with a wheel taken. The autonomous mobile body 10 according to the present embodiment may be, for example, a compact robot with a size and a weight that a user is able to easily pick up with one hand.

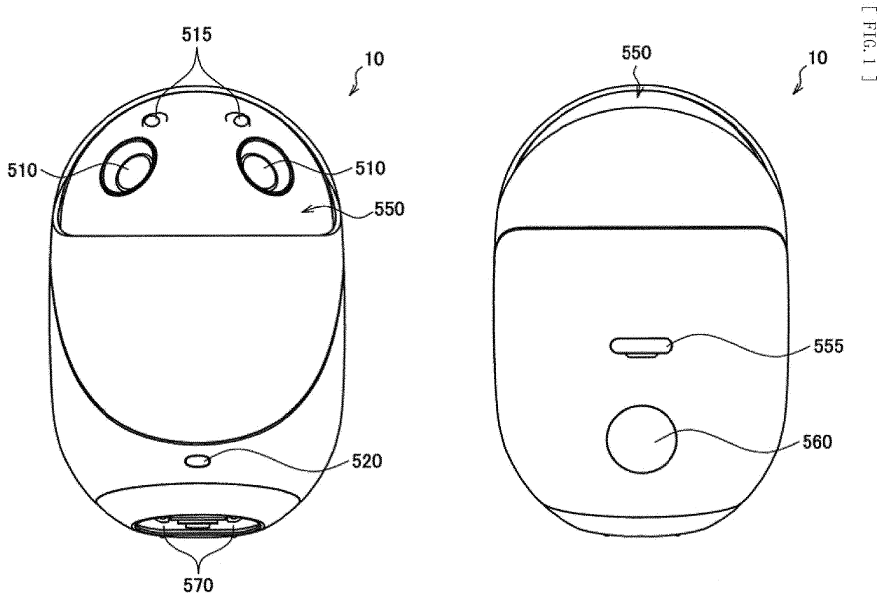

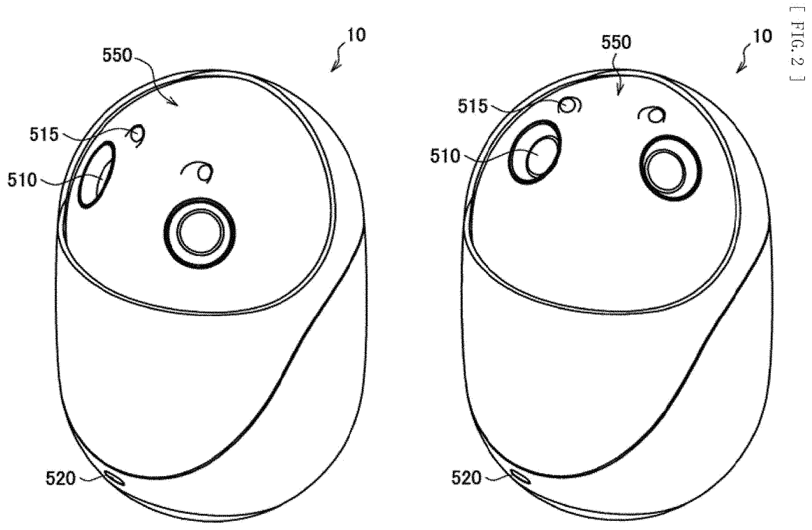

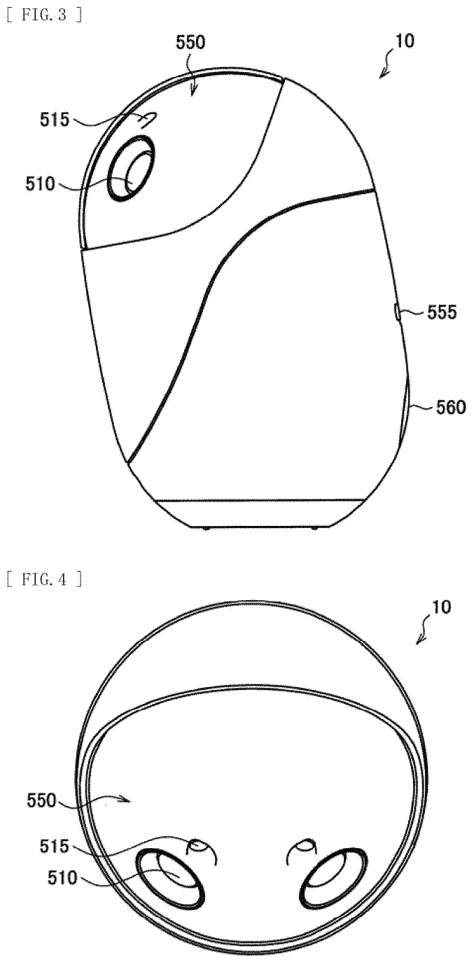

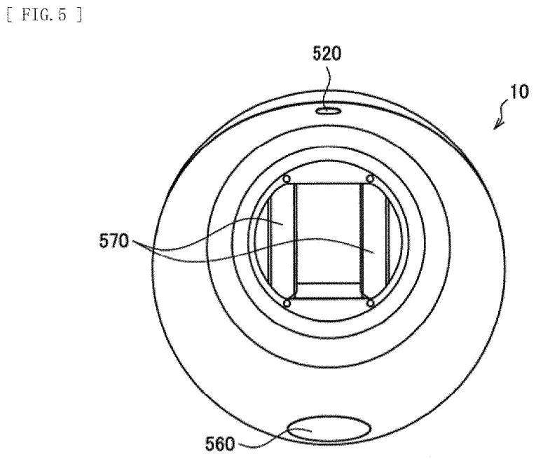

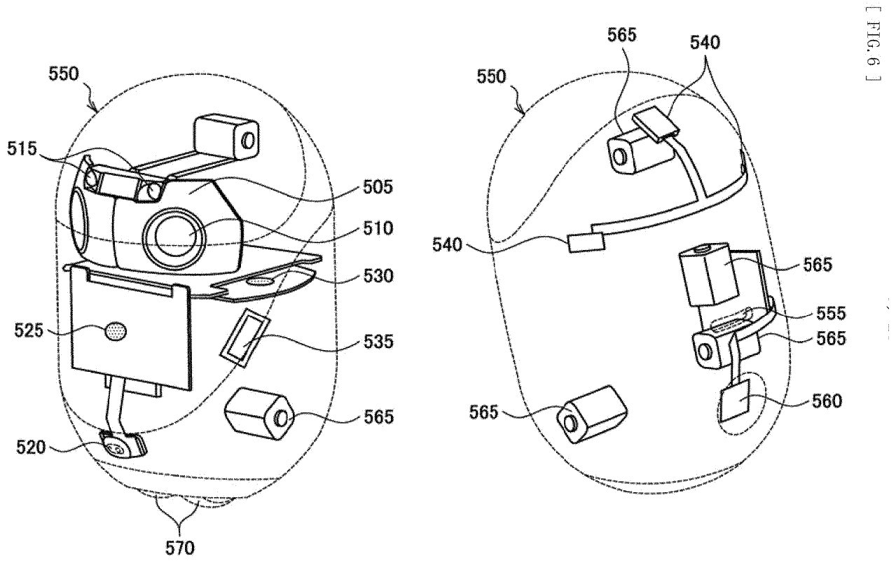

First, referring to FIGS. 1 to 5, description is made on an example regarding an exterior of the autonomous mobile body 10 according to the present embodiment. FIG. 1 is a front view and a back view of the autonomous mobile body 10 according to the present embodiment. Further, FIG. 2 is a perspective view of the autonomous mobile body 10 according to the present embodiment. Further, FIG. 3 is a side view of the autonomous mobile body 10 according to the present embodiment. Further, FIG. 4 and FIG. 5 are respectively a top view and a bottom view of the autonomous mobile body 10 according to the present embodiment.

As illustrated in FIGS. 1 to 4, the autonomous mobile body 10 according to the present embodiment includes two eyes 510, which correspond to a right eye and a left eye, at an upper portion of a main body. The eyes 510, each of which includes, for example, an LED or the like, are able to express a line of sight, blink, etc. It is to be noted that the eyes 510 are not limited to the above-described example but may each include, for example, a single or independent two OLEDs (Organic Light Emitting Diodes) or the like.

Further, the autonomous mobile body 10 according to the present embodiment includes two cameras 515 above the eyes 510. The cameras 515 each have a function to capture an image of a user or a surrounding environment. Further, the autonomous mobile body 10 enables SLAM (Simultaneous Localization and Mapping) on the basis of the image captured by the cameras 515.

It is to be noted that the eyes 510 and the cameras 515 according to the present embodiment are mounted on a substrate 505 disposed in an interior at an exterior surface. Further, while an opaque material is basically used for the exterior surface of the autonomous mobile body 10 of the present embodiment, a head cover 550 including a transparent or semitransparent material is provided at a portion corresponding to the substrate 505 on which the eyes 510 and the cameras 515 are mounted. This allows a user to recognize the eyes 510 of the autonomous mobile body 10 and allows the autonomous mobile body 10 to capture an image of an outside world.

Further, as illustrated in FIG. 1, FIG. 2, and FIG. 5, the autonomous mobile body 10 according to the present embodiment includes a ToF sensor 520 at a front lower portion. The ToF sensor 520 has a function to detect a distance to an object lying in front thereof. The ToF sensor 520 is able to detect distances to various objects with a high accuracy and, further, to prevent itself from dropping or falling by detecting a step or the like.

Further, as illustrated in FIG. 1, FIG. 3, etc., the autonomous mobile body 10 according to the present embodiment may include a coupling terminal 555 for an external device and a power switch 560 at a back thereof. The autonomous mobile body 10 is able to be coupled to the external device through the coupling terminal 555 to perform information communication.

Further, as illustrated in FIG. 5, the autonomous mobile body 10 according to the present embodiment includes two wheels 570 at a bottom thereof. The wheels 570 according to the present embodiment are to be driven by respective different motors 565. This enables the autonomous mobile body 10 to perform a transfer motion such as advance, retreat, turn, or rotation. Further, the wheels 570 according to the present embodiment are configured to be storable inside the main body and externally projectable. For example, with the two wheels 570 swiftly externally projected, the autonomous mobile body 10 according to the present embodiment is also able to perform a jumping motion. It is to be noted that FIG. 5 illustrates a state where the wheels 570 are stored inside the main body.

In the foregoing, the exterior of the autonomous mobile body 10 according to the present embodiment has been described. Subsequently, description is made on an interior structure of the autonomous mobile body 10 according to the present embodiment. FIG. 6 is a schematic diagram of assistance in explaining the interior structure of the autonomous mobile body 10 according to the present embodiment.

As illustrated on a left side in FIG. 6, the autonomous mobile body 10 according to the present embodiment includes an inertia sensor 525 and a communication device 530 mounted on an electronic substrate. The inertia sensor 525 detects an acceleration and an angular speed of the autonomous mobile body 10. Further, the communication device 530, which is a component for enabling external wireless communication, includes, for example, a Bluetooth (registered trademark) or Wi-Fi (registered trademark) antenna, etc.

Further, the autonomous mobile body 10 includes, for example, a speaker 535 in the interior at a lateral side of the main body. The autonomous mobile body 10 is able to output various sound information, which includes voice, through the speaker 535.

Further, as illustrated on a right side in FIG. 6, the autonomous mobile body 10 according to the present embodiment includes a plurality of microphones 540 in the interior at the upper portion of the main body. The microphones 540 collect a speech of a user and an ambient sound therearound. Further, with the plurality of microphones 540 provided, the autonomous mobile body 10 is able to collect a sound generated therearound with a high sensibility and enable localization of a sound source.

Further, the autonomous mobile body 10 includes a plurality of motors 565 as illustrated in FIG. 6. The autonomous mobile body 10 may include, for example, two motors 565 for driving the substrate on which the eyes 510 and the cameras 515 are mounted in a perpendicular direction and a horizontal direction, two motors 565 for driving the right and left wheels 570, and one motor 565 for enabling a forward-tilting attitude of the autonomous mobile body 10. The autonomous mobile body 10 according to the present embodiment is able to express a more expressive motion by virtue of the plurality of motors 565.

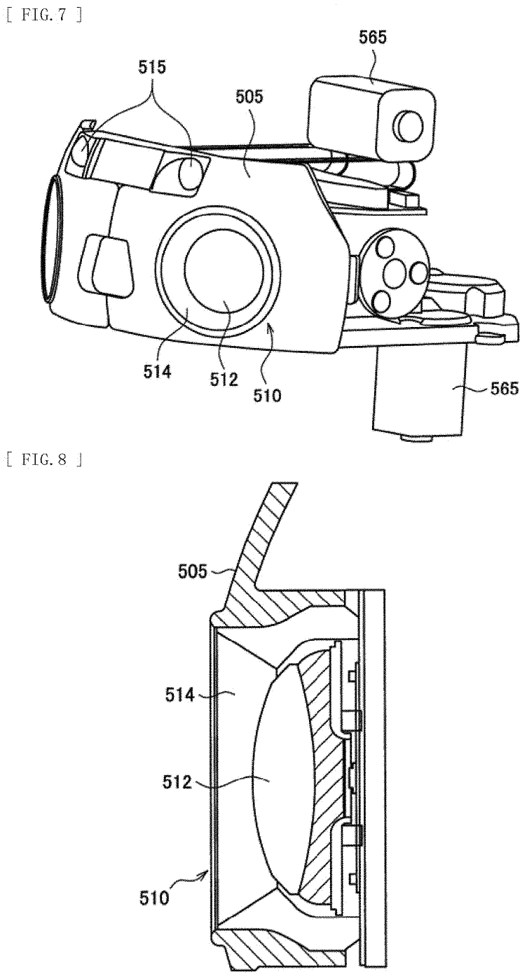

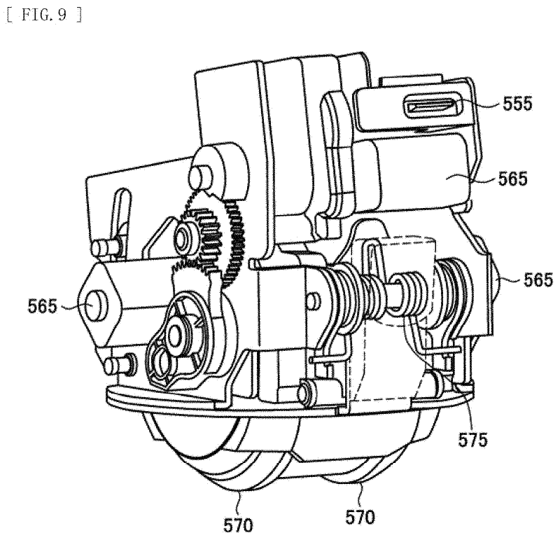

Next, detailed description is made on a configuration of the substrate 505 on which the eyes 510 and the cameras 515 are mounted and a configuration of the eyes 510 according to the present embodiment. FIG. 7 is a diagram illustrating the configuration of the substrate 505 according to the present embodiment. Further, FIG. 8 is one cross-sectional view of the substrate 505 according to the present embodiment. Referring to FIG. 7, the substrate 505 according to the present embodiment is coupled to the two motors 565. As described above, the two motors 565 are able to drive the substrate 505 on which the eyes 510 and the cameras 515 are mounted in the perpendicular direction and the horizontal direction. This makes it possible to flexibly move the eyes 510 of the autonomous mobile body 10 in the perpendicular direction and the horizontal direction, allowing for expressing an expressive eye motion that is in accordance with a situation or a motion.

Further, as illustrated in FIG. 7 and FIG. 8, the eyes 510 each include a middle portion 512 corresponding to an iris and a peripheral portion 514 corresponding to a so-called white of the eye. The middle portion 512 expresses any colors including blue, red, green, etc., and the peripheral portion 514 expresses white. As such, the configuration of each of the eyes 510 is divided into two, thereby allowing the autonomous mobile body 10 according to the present embodiment to express a natural eye expression closer to that of an actual creature.

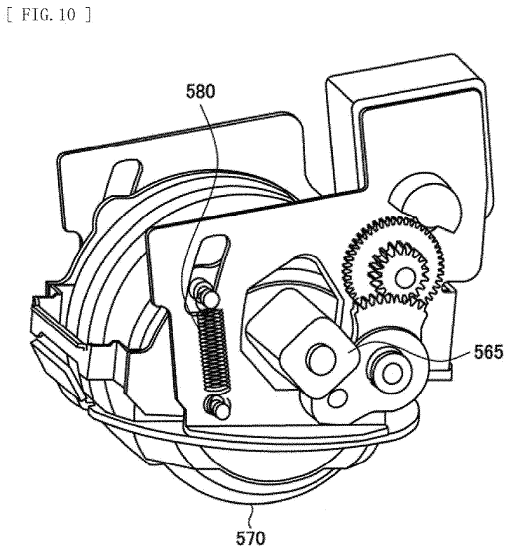

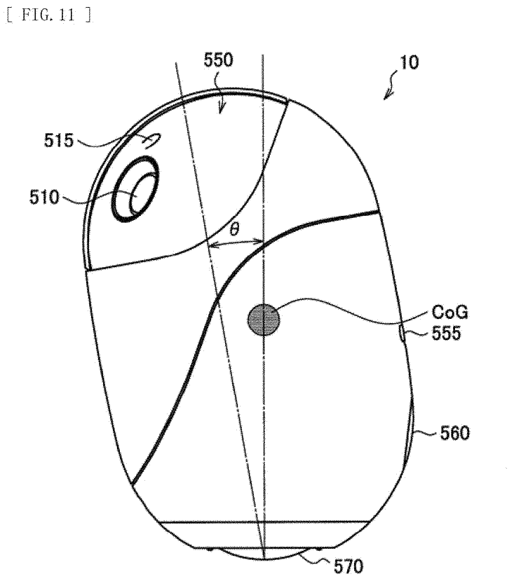

Next, referring to FIG. 9 and FIG. 10, detailed description is made on a structure of the wheels 570 according to the present embodiment. FIG. 9 and FIG. 10 are each a diagram illustrating a surrounding structure of each of the wheels 570 according to the present embodiment. As illustrated in FIG. 9, the two wheels 570 according to the present embodiment are to be driven by the respective independent motors 565. Such a configuration allows for finely expressing a transfer motion such as turn or rotation on the spot in addition to simple advance and retreat.

Further, the wheels 570 according to the present embodiment are configured to be storable inside the main body and externally projectable as described above. Further, a dumper 575 is disposed coaxially with the wheels 570 according to the present embodiment, thereby allowing for effectively reducing transmission of impact or vibration to an axle or the main body.

Further, as illustrated in FIG. 10, the wheels 570 according to the present embodiment may each be provided with an auxiliary spring 580. Although driving, among portions to be driven of the autonomous mobile body 10, the wheels according to the present embodiment requires the largest torque. However, with the auxiliary spring 580 provided, it is possible to use in common all the motors 565 instead of using the different motors 565 for respective portions to be driven.

Next, description is made on a feature of the autonomous mobile body 10 according to the present embodiment during travel. FIG. 1I is a diagram of assistance in explaining a forward-tilting travel of the autonomous mobile body 10 according to the present embodiment. One of the features of the autonomous mobile body 10 according to the present embodiment is performing the transfer motion such as forward and backward movement, turning movement, or rotary movement with the forward-tilting attitude maintained. FIG. 11 illustrates an appearance of the autonomous mobile body 10 during travel as viewed from the lateral side.

As illustrated in FIG. 11, one of the features of the autonomous mobile body 10 according to the present embodiment is performing the transfer motion while tilting in a forward direction only by an angle θ with respect to the perpendicular direction. The angle θ may be 10°, for example.

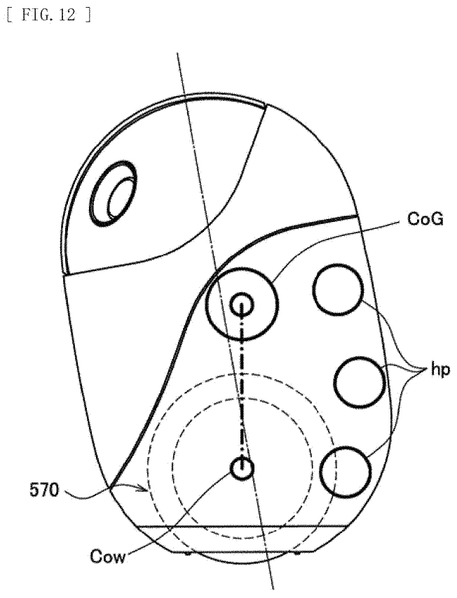

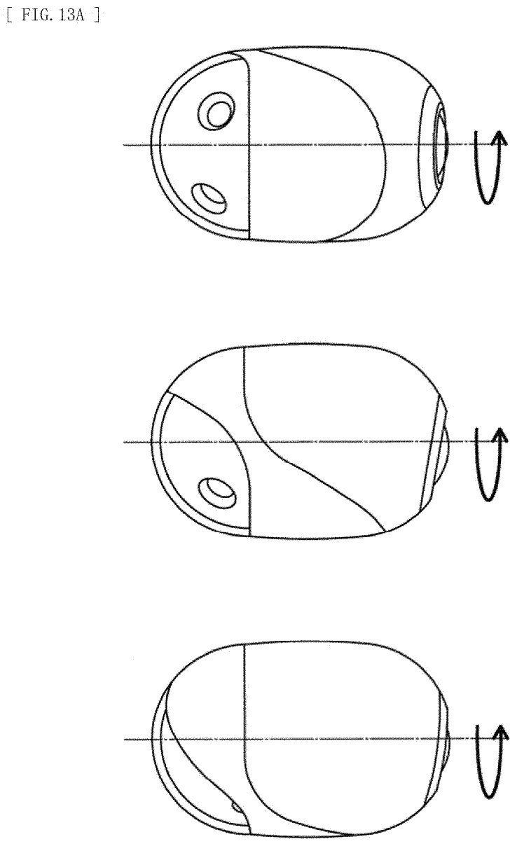

In this regard, a later-described motion controller 230 of the information processing server 20 controls the transfer motion of the autonomous mobile body 10 to cause a center of gravity CoG of the autonomous mobile body 10 to be positioned on a vertical line with respect to a rotation axis CoW of the wheels 570 as illustrated in FIG. 12. Further, a weight component hp for keeping balance in the forward-tilting attitude is disposed on a back side of the autonomous mobile body 10 according to the present embodiment. The weight component hp according to the present embodiment may be a component heavier than any other component of the autonomous mobile body 10, and may be the motor 565, a battery, or the like. The above-described component location facilitates gyro control with the balance kept even when the head tilts forward, allowing for preventing unintended fall of the autonomous mobile body 10 to enable a stable forward-tilting travel.

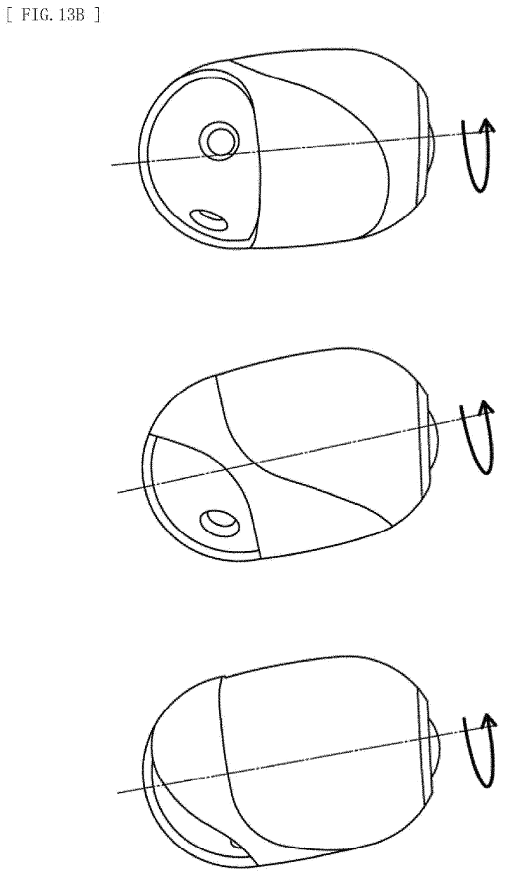

Subsequently, more detailed description is made on the transfer motion of the autonomous mobile body 10 according to the present embodiment with the forward-tilting attitude maintained. FIG. 13A and FIG. 13B are each a diagram of assistance in explaining an effect achieved by a forward-tilting motion of the autonomous mobile body 10 according to the present embodiment.

Here, FIG. 13A illustrates an example of a rotary motion in a case where the autonomous mobile body is not in the forward-tilting attitude. As illustrated in FIG. 13A, in a case where the autonomous mobile body 10 performs the transfer motion, such as rotation or forward and backward movement, not in the forward-tilting attitude with the long ellipsoid erected, no directionality is given in the long ellipsoidal body, making it difficult to eliminate impression that the autonomous mobile body is an artificial object.

In contrast, as illustrated in FIG. 13B, one of the features of the autonomous mobile body 10 according to the present embodiment is performing the transfer motion such as rotation with the forward-tilting attitude maintained. Such a feature makes an upper front portion of the autonomous mobile body 10 reminiscent of a head and a lower back portion thereof reminiscent of a waist, generating directionality even in the simple long ellipsoid.

The forward-tilting motion of the autonomous mobile body 10 according to the present embodiment thus allows a structure corresponding to a body part of a person to be expressed by the relatively simple exterior and such personification of the simple form makes it possible to give the user an impression as if it were a life form beyond a mere artifact. As described above, the forward-tilting motion according to the present embodiment makes it possible to expressively express a facial expression of the robot with the relatively simple exterior such as a long ellipsoid and, further, can be said to be a remarkably effective means to evoke a complicated motion such as that of an actual creature.

In the foregoing, the detailed description has been made on the configuration example of the autonomous mobile body 10 according to one embodiment of the present disclosure. It is to be noted that the above configuration described with reference to FIGS. 1 to 13B is merely one example and the configuration of the autonomous mobile body 10 according to one embodiment of the present disclosure is not limited to such an example. The form and the internal structure of the autonomous mobile body 10 according to the present embodiment may be designed as desired. The autonomous mobile body 10 according to the present embodiment may be implemented as, for example, a walking, flying, or swimming robot.

### <<1.3. System Configuration Example>>

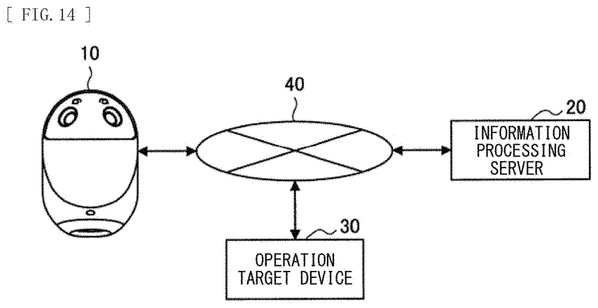

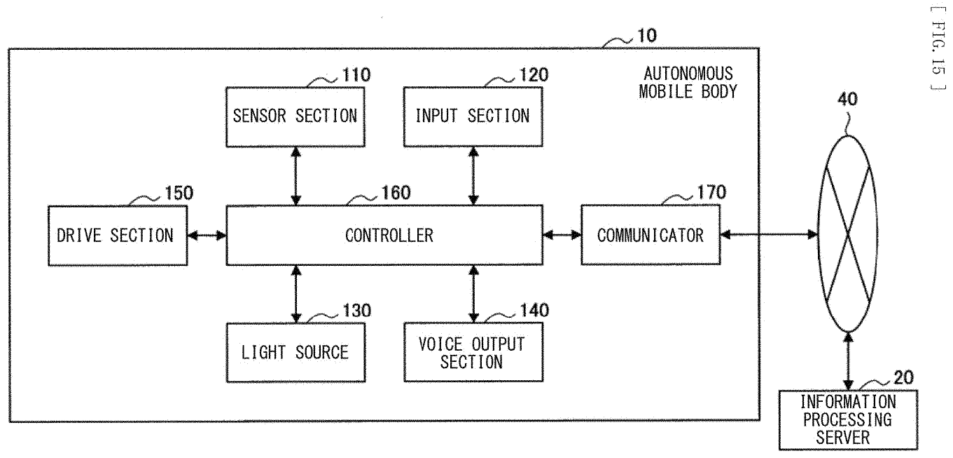

Next, description is made on a configuration example of an information processing system according to one embodiment of the present disclosure. FIG. 14 is a block diagram illustrating the configuration example of the information processing system according to the present embodiment. Referring to FIG. 14, the information processing system according to the present embodiment includes the autonomous mobile body 10, the information processing server 20, and an operation target device 30. Further, the components are coupled through a network 40.

### (Autonomous Mobile Body 10)

The autonomous mobile body 10 according to the present embodiment is an information processor that performs an autonomous motion based on control by the information processing server 20. The autonomous mobile body 10 according to the present embodiment may be a variety of robots such as a travelling type, a walking type, a flying type, and a swimming type as described above.

### (Information Processing Server 20)

The information processing server 20 according to the present embodiment is an information processor that controls the motion of the autonomous mobile body 10. The information processing server 20 according to the present embodiment has a function to cause the autonomous mobile body 10 to perform various inducing motions that induce communication with a user. It is to be noted that one of features of the above-described inducing motions and communication is to include a behavior of the autonomous mobile body 10 in a physical space.

### (Operation Target Device 30)

The operation target device 30 according to the present embodiment is a variety of devices to be operated by the information processing server 20 and the autonomous mobile body 10. The autonomous mobile body 10 according to the present embodiment is able to operate the various operation target devices 30 on the basis of the control by the information processing server 20. The operation target device 30 according to the present embodiment may be, for example, a home appliance such as lighting equipment, a game device, or television equipment.

### (Network 40)

The network 40 has a function to couple the components of the information processing system. The network 40 may include public networks such as the Internet, a telephone network, and a satellite communication network and various LAN (Local Area Network) including Ethernet (registered trademark), WAN (Wide Area Network), etc. The network 40 may also include leased networks such as IP-VPN (Internet Protocol-Virtual Private Network). The network 40 may also include wireless networks such as Wi-Fi (registered trademark) and Bluetooth (registered trademark).

In the foregoing, the description has been made on the system configuration example according to one embodiment of the present disclosure. It is to be noted that the above configuration described with reference to FIG. 14 is merely one example and the configuration of the information processing system according to one embodiment of the present disclosure is not limited to such an example. For example, a control function of the information processing server 20 may be implemented as a function of the autonomous mobile body 10. The system configuration according to one embodiment of the present disclosure may be flexibly modified in accordance with specifications or practical application.

### <<1.4. Functional Configuration Example of Autonomous Mobile Body 10>>

Next, description is made on a functional configuration example of the autonomous mobile body 10 according to one embodiment of the present disclosure. FIG. 15 is a block diagram illustrating the functional configuration example of the autonomous mobile body 10 according to the present embodiment. Referring to FIG. 15, the autonomous mobile body 10 according to the present embodiment includes a sensor section 110, an input section 120, a light source 130, a voice output section 140, a drive section 150, a controller 160, and a communicator 170.

### (Sensor Section 110)

The sensor section 110 according to the present embodiment has a function to collect various sensor information regarding a user and surroundings. Accordingly, the sensor section 110 according to the present embodiment includes, for example, the cameras 515, the ToF sensor 520, the microphones 540, the inertia sensor 525, etc., described above. Further, in addition to the above, the sensor section 110 may include a variety of sensors such as a geomagnetic sensor, a touch sensor, various optical sensors including an infrared sensor, a temperature sensor, and a humidity sensor.

### (Input Section 120)

The input section 120 according to the present embodiment has a function to detect a physical input operation by a user. The input section 120 according to the present embodiment includes, for example, a button such as a power switch 560.

### (Light Source 130)

The light source 130 according to the present embodiment expresses an eye motion of the autonomous mobile body 10. Accordingly, the light source 130 according to the present embodiment includes the two eyes 510.

### (Voice Output Section 140)

The voice output section 140 according to the present embodiment has a function to output various sounds including voice. Accordingly, the voice output section 140 according to the present embodiment includes the speaker 535, an amplifier, etc.

### (Drive Section 150)

The drive section 150 according to the present embodiment expresses a body motion of the autonomous mobile body 10. Accordingly, the drive section 150 according to the present embodiment includes the two wheels 570 and the plurality of motors 565.

### (Controller 160)

The controller 160 according to the present embodiment has a function to control the components of the autonomous mobile body 10. The controller 160 controls, for example, start and stop of the components. Further, the controller 160 inputs a control signal generated by the information processing server 20 to the light source 130, the voice output section 140, or the drive section 150. Further, the controller 160 according to the present embodiment may have a function comparable to the later-described motion controller 230 of the information processing server 20.

### (Communicator 170)

The communicator 170 according to the present embodiment performs information communication with the information processing server 20, the operation target device 30, or any other external device. Accordingly, the communicator 170 according to the present embodiment includes the coupling terminal 555 and the communication device 530.

In the foregoing, the description has been made on the functional configuration example of the autonomous mobile body 10 according to one embodiment of the present disclosure. It is to be noted that the above configuration described with reference to FIG. 15 is merely one example and the functional configuration of the autonomous mobile body 10 according to one embodiment of the present disclosure is not limited to such an example. For example, the autonomous mobile body 10 according to the present embodiment does not necessarily include all the components illustrated in FIG. 15. The functional configuration of the autonomous mobile body 10 according to the present embodiment may be flexibly modified in accordance with the form of the autonomous mobile body 10, etc.

### <<1.5. Functional Configuration Example of Information Processing Server 20>>

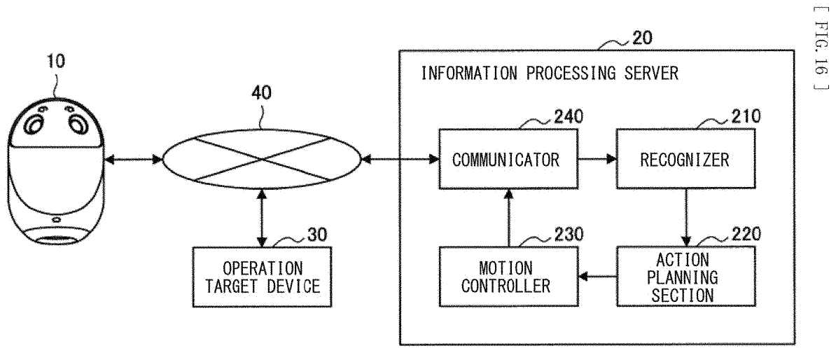

Next, description is made on a functional configuration example of the information processing server 20 according to one embodiment of the present disclosure. FIG. 16 is a block diagram illustrating the functional configuration example of the information processing server 20 according to the present embodiment. Referring to FIG. 16, the information processing server 20 according to the present embodiment includes a recognizer 210, an action planning section 220, the motion controller 230, and a communicator 240.

### (Recognizer 210)

The recognizer 210 has a function to perform various recognition related to a user, a surrounding environment, and a state of the autonomous mobile body 10 on the basis of the sensor information collected by the autonomous mobile body 10. As an example, the recognizer 210 may perform user recognition, recognition of facial expression and line of sight, object recognition, color recognition, shape recognition, marker recognition, obstacle recognition, step recognition, brightness recognition, and the like.

Further, the recognizer 210 performs emotion recognition, word understanding, sound source localization. etc. related to a voice of a user. Further, the recognizer 210 is able to recognize an ambient temperature, the presence of an animal body, an attitude of the autonomous mobile body 10, etc.

Still further, the recognizer 210 has a function to presume and understand the surrounding environment and situation where the autonomous mobile body 10 is on the basis of the recognized above-described information. In this regard, the recognizer 210 may comprehensively presume the situation using prestored environmental knowledge.

### (Action Planning Section 220)

The action planning section 220 has a function to plan an action to be performed by the autonomous mobile body 10 on the basis of the situation presumed by the recognizer 210 and learned knowledge. The action planning section 220 performs action planning by, for example, machine learning algorism such as deep learning.

### (Motion Controller 230)

The motion controller 230 according to the present embodiment performs a motion control of the autonomous mobile body 10 on the basis of the action planning performed by the action planning section 220. For example, the motion controller 230 may cause the autonomous mobile body 10 having a long ellipsoidal contour to perform the transfer motion with the forward-tilting attitude maintained. The above-described transfer motion includes the forward and backward movement, the turning movement, the rotary movement, and the like as described above. Further, one of the features of the motion controller 230 according to the present embodiment is causing the autonomous mobile body 10 to actively perform the inducing motions that induce communication between a user and the autonomous mobile body 10. As described above, the inducing motions and the communication according to the present embodiment may include a physical behavior of the autonomous mobile body 10 in a physical space. The details of the inducing motions enabled by the motion controller 230 according to the present embodiment will be described later separately.

### (Communicator 240)

The communicator 240 according to the present embodiment performs information communication with the autonomous mobile body 10 or a target to operate. For example, the communicator 240 receives sensor information from the autonomous mobile body 10 and outputs a control signal related to a motion to the autonomous mobile body 10.

In the foregoing, the description has been made on the functional configuration example of the information processing server 20 according to one embodiment of the present disclosure. It is to be noted that the above configuration described with reference to FIG. 16 is merely one example and the functional configuration of the information processing server 20 according to one embodiment of the present disclosure is not limited to such an example. For example, a variety of functions of the information processing server 20 may be distributed to be implemented by a plurality of devices. Further, the functions of the information processing server 20 may be implemented as the functions of the autonomous mobile body 10. The functional configuration of the information processing server 20 according to the present embodiment may be flexibly modified in accordance with specifications and practical application.

### <<1.6. Details of Inducing Motions>>

Next, description is made on the inducing motions of the autonomous mobile body 10 enabled by the motion controller 230 according to the present embodiment with reference to specific examples. As described above, the autonomous mobile body 10 according to the present embodiment is able to actively perform the various inducing motions on the basis of control by the motion controller 230. Further, the autonomous mobile body 10 according to the present embodiment performs the inducing motions accompanied with a physical behavior, thereby allowing for more impressively encouraging a user and accelerating the communication.

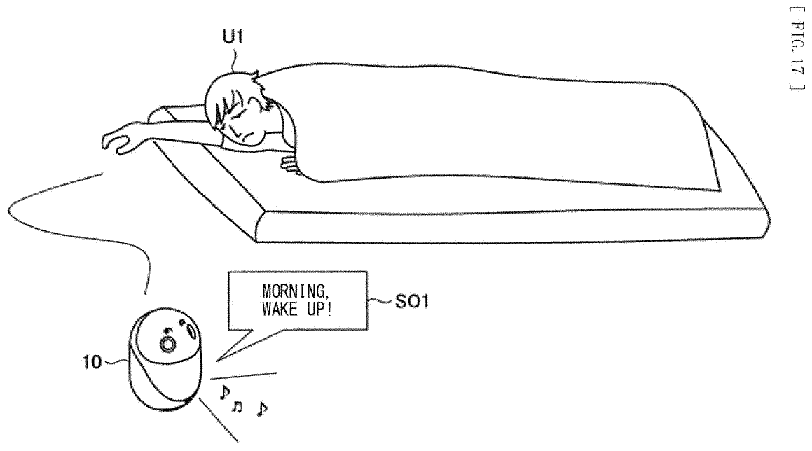

The inducing motions according to the present embodiment may include, for example, a motion for causing a user to perform a predetermined action. FIGS. 17 to 20 are diagrams each illustrating an example of an inducing motion for causing a user to perform a predetermined action.

FIG. 17 illustrates an example of a case where the autonomous mobile body 10 performs an inducing motion to encourage a user to wake up. The motion controller 230 according to the present embodiment is able to cause the autonomous mobile body 10 to perform the inducing motion to encourage a user U1 to wake up on the basis of, for example, a user's daily wake-up habit or a user's schedule of the day.

In this regard, the motion controller 230 causes the autonomous mobile body 10 to output a voice speech SO1 such as “Morning, Wake up!” or an alarm sound or BGM. As such, the inducing motions according to the present embodiment include voice inducement for communication. In this regard, the motion controller 230 according to the present embodiment may deliberately limit the number of words of voice (making a smattering) to be outputted from the autonomous mobile body 10 or make the words random, thereby expressing loveliness, lovableness, or the like. It is to be noted that the fluency of the voice of the autonomous mobile body 10 may be improved by learning or the autonomous mobile body 10 may be originally designed so as to fluently speak. Alternatively, the fluency of the voice of the autonomous mobile body 10 may be changed on the basis of setting by the user.

Further, in this regard, if the user U1 tries to stop the voice speech SO1 or the alarm sound or the like, the motion controller 230 may cause the autonomous mobile body 10 to perform an inducing motion of running away from the user U1 so as to hamper such a stopping motion. As such, the motion controller 230 and the autonomous mobile body 10 according to the present embodiment allow for enabling a deeper continuous communication accompanied with the physical motion unlike a case where an alarm sound is merely passively outputted at a set time.

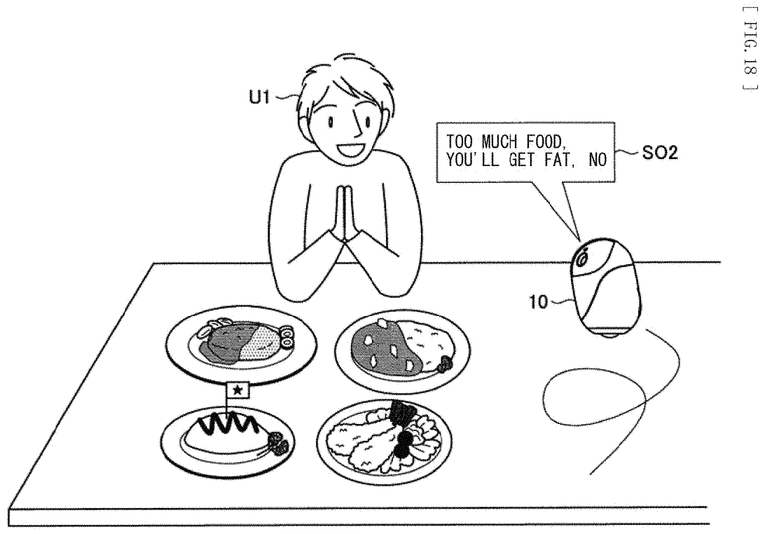

Further, FIG. 18 illustrates an example of a case where the autonomous mobile body 10 performs an inducing motion to encourage the user U1 to stop eating too much. As such, the inducing motions for causing predetermined actions to be performed according to the present embodiment may include a motion for stopping a predetermined action. In a case of the example illustrated in FIG. 18, the motion controller 230 causes the autonomous mobile body 10 to perform an inducing motion of outputting a voice speech SO2 such as “Too much food, You'll get fat, No” while running around on the table.

As such, as compared with a case where a warning for health condition or the like based on image recognition or the like is passively given merely by voice, the motion controller 230 and the autonomous mobile body 10 according to the present embodiment give a warning accompanied with a physical motion, thereby allowing for giving a deeper impression to the user with an enhanced effect in warning. Further, the inducing motion as illustrated is expected to have an effect in necessitating further communication such that the user, who feels annoyed by this inducing motion, tries to stop the inducing motion or complains to the autonomous mobile body 10.

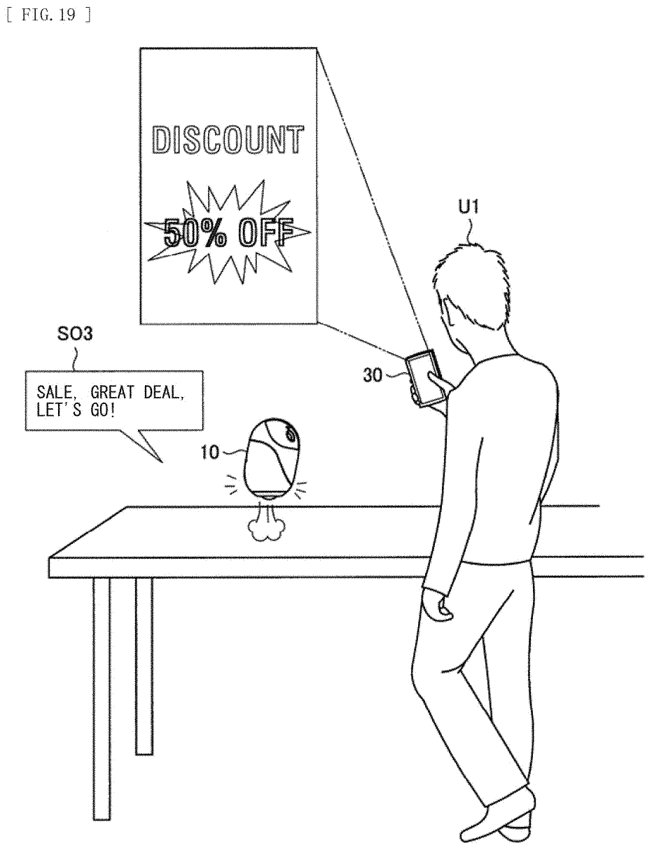

Further, FIG. 19 illustrates an example of a case where the autonomous mobile body 10 performs an inducing motion of presenting sale information to the user U1 to invite the user to this sale. As such, the information processing server 20 according to the present embodiment is able to cause the autonomous mobile body 10 to present various information on the basis of store information and event information collected through the network, preference of the user, or the like.

In a case of the example illustrated in FIG. 19, the motion controller 230 causes the autonomous mobile body 10 to output a voice speech SO3 such as “Sale, Great Deal, Let's Go” while causing the operation target device 30 carried by the user U1 to display sale information. In this regard, the control of the sale information to be displayed on the operation target device 30 may be performed directly by the motion controller 230 or performed by the controller 160 of the autonomous mobile body 10 via the communicator 170.

Further, in the case of the example illustrated in FIG. 19, the motion controller 230 causes the autonomous mobile body 10 to output the voice speech SO3 while causing the autonomous mobile body 10 to perform an inducing motion including jumping. As described above, with the wheels 570 swiftly externally projected, the autonomous mobile body 10 according to the present embodiment is able to perform the jumping motion.

As such, as compared with a case where recommendation information is provided merely by voice or using visual information, the motion controller 230 and the autonomous mobile body 10 according to the present embodiment perform recommendation accompanied with the physical motion, thereby allowing for giving a deeper impression to the user with an enhanced effect in information presentation.

Further, the motion controller 230 according to the present embodiment may cause the autonomous mobile body 10 to output a voice speech such as “Take Me, Go Together” at this time. The autonomous mobile body 10 according to the present embodiment, which has a size and a weight that the user is able to easily pick up with one hand, may be sized so as to be, for example, stored in a plastic bottle holder provided in a vehicle. This allows the user to casually take the autonomous mobile body 10 outside. Further, for example, during transportation by vehicle, the motion controller 230 causes the autonomous mobile body 10 to perform navigation to a destination or the like, thereby allowing for enhancing convenience for the user.

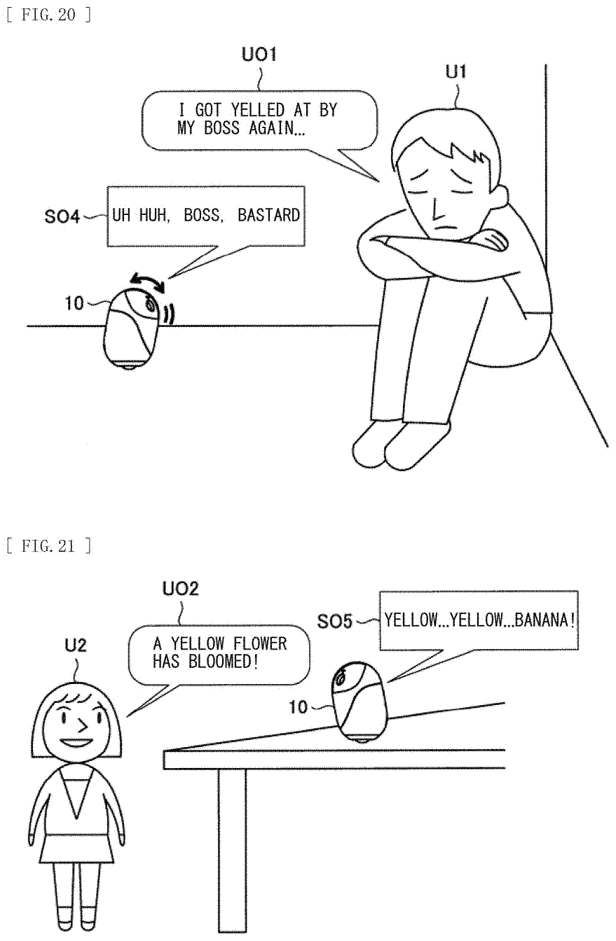

Further, FIG. 20 illustrates an example of a case where the autonomous mobile body 10 performs an inducing motion to encourage the user U1 to continue a talk. In the case of the example illustrated in FIG. 20, the motion controller 230 controls the drive section 150 of the autonomous mobile body 10 to repeat the forward-tilting motion and a backward-tilting motion, thereby expressing a nod (supportive response). Further, in this regard, the motion controller 230 may cause the autonomous mobile body 10 to output a voice speech SO4 using a word included in a user speech UO1 of the user U1 to emphasize that the speech of the user U is listened to.

It is to be noted that if recognizing that the user U1 is depressed, the information processing server 20 may cause the autonomous mobile body 10 to perform the above-described inducing motion. For example, the motion controller 230 causes the autonomous mobile body 10 to approach the user U1 while causing the autonomous mobile body 10 to output a voice speech such as “What's up?” or “I can listen to you.”, thereby allowing for giving an opportunity for the user U1 to talk.

As such, as compared with a case where a response is simply given to the speech of a user, the motion controller 230 and the autonomous mobile body 10 according to the present embodiment make it possible to behave toward a user as a more familiar and closer conversation partner, allowing for enabling a deeper continuous communication.

Further, the inducing motions according to the present embodiment may include a motion for encouraging a user to perform a collaborative action with the autonomous mobile body 10. Such a collaborative action includes, for example, a game played by the user and the autonomous mobile body 10. That is, the motion controller 230 according to the present embodiment is able to cause the autonomous mobile body 10 to perform an inducing action to invite the user to the game.

FIGS. 21 to 24 are each a diagram illustrating an example of an inducing action that induces a collaborative action of a user and the autonomous mobile body 10 according to the present embodiment. FIG. 21 illustrates an example of a case where the autonomous mobile body 10 plays an association game with a user U2. As such, games for which the inducing motion of the autonomous mobile body 10 is intended may include a game using language. It is to be noted that examples of the game using language include “Shiritori” in a Japanese-speaking area (“Word Chain” in an English-speaking area) and a word guessing game (Charades) where the autonomous mobile body 10 answers a phrase expressed by a gesture of the user, in addition to the association game illustrated in FIG. 21.

In this regard, the motion controller 230 may cause the autonomous mobile body 10 to perform explicit invitation to the game by a voice speech or may suddenly start the game in a unilateral manner to invite the user to participate in the game on the basis of a speech of the user. In the example illustrated in FIG. 21, the motion controller 230 causes, on the basis of a user speech UO2 of “A yellow flower has bloomed” spoken by the user U2, the autonomous mobile body 10 to output a voice speech SO5 for the start of the association game with “Yellow” included in this speech.

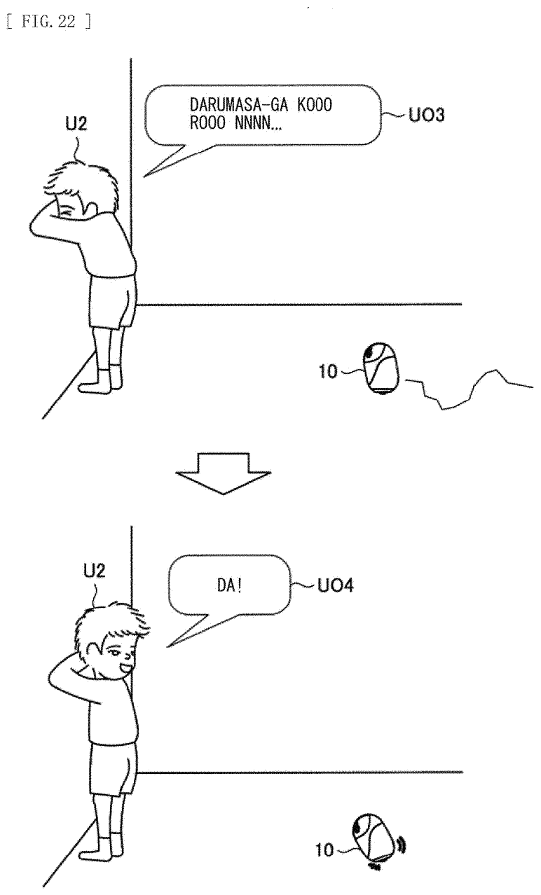

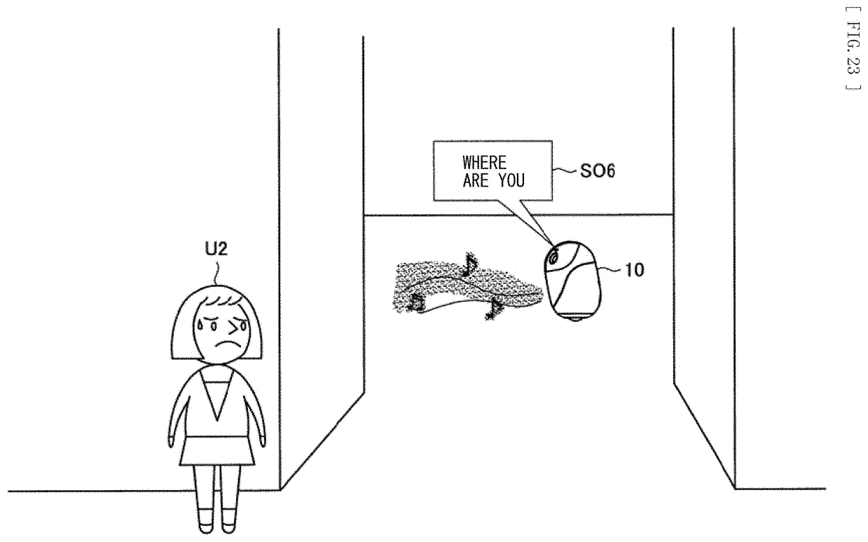

Further, FIG. 22 illustrates an example of a case where the autonomous mobile body 10 and the user U2 play “Daruma-San ga Koronda” (corresponding to “Red light/Green Light”, “Statues”, or the like). As such, the games for which the inducing motion of the autonomous mobile body 10 is intended include a game necessitating physical motions of the user and the autonomous mobile body 10.

The autonomous mobile body 10 according to the present embodiment, which includes the two wheels 570 as described above, is able to advance, look back, and the like and thus able to perform a game such as “Daruma-San ga Koronda” with the user. It is to be noted that the recognizer 210 of the information processing server 20 detects a face of the user included in the image captured by the autonomous mobile body 10, thereby being able to recognize a look-back act of the user. Alternatively, the recognizer 210 may recognize the look-back act of the user from user speeches UO3 and UO4 or the like. In this case, the action planning section 220 plans, on the basis of the recognition of the look-back act, an action such as stopping on the spot or deliberately falling forward, and the motion controller 230 controls the drive section 150 of the autonomous mobile body 10 on the basis of this plan. It is to be noted that the autonomous mobile body 10 according to the present embodiment, which includes a pendulum or the like therein, is able to restore itself from a fallen state.

It is to be noted that the motion controller 230 may suddenly start the game in a unilateral manner as in the case of the association game to invite the user to participate in the game. In this regard, the information processing server 20 repeats control to cause the autonomous mobile body 10 to stop the motion if the line of sight of the user is directed to the autonomous mobile body 10 and to perform an approaching motion to the user if the line of sight of the user is moved therefrom, thereby making it possible to invite the user to the game.

Further, FIG. 23 illustrates an example of a case where the autonomous mobile body 10 plays “Kakurenbo” (corresponding to “Hide and seek”) with the user U2. In a case of the example illustrated in FIG. 23, the motion controller 230 causes the autonomous mobile body 10 to output eerie BGM along with a voice speech SO6 indicating that it is looking for the user U2. Such control makes it possible to effectively express the sense of presence of the autonomous mobile body 10, which is gradually approaching the user U2, allowing for a deeper communication.

It is to be noted that the information processing server 20 allows the autonomous mobile body 10 to look for the user U2, for example, using a SLAM map generated in advance or by performing sound source localization related to sound information collected when the user U2 is running away or a sound made nearby.

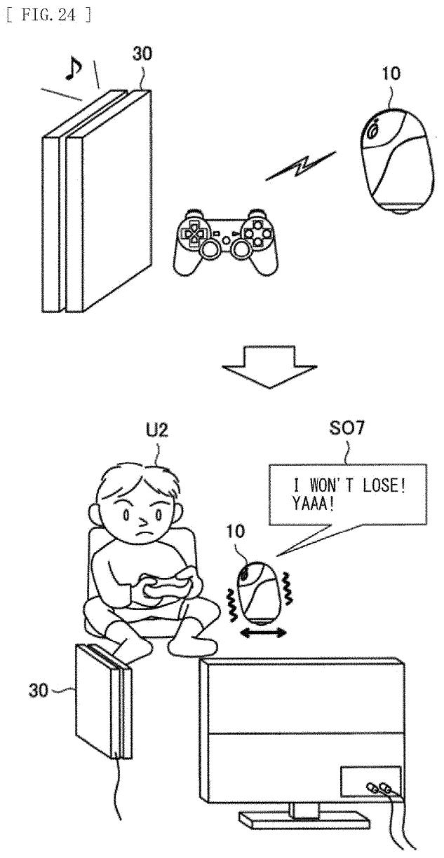

Further, FIG. 24 illustrates an example of a case where the autonomous mobile body 10 plays a computer game with the user U2. As such, the games for which the inducing motion of the autonomous mobile body 10 according to the present embodiment is intended may include a computer game.

In this case, for example, the motion controller 230 may cause the autonomous mobile body 10 to perform a motion that causes the operation target device 30, that is, a game device, to start by itself. As such, the motion controller 230 is able to cause the autonomous mobile body 10 to perform a motion that is not intended by the user or does not match an intention, that is, a motion such as a trick. Such a trick includes, for example, an operation of the operation target device 30 as illustrated.

Here, in a case where the user U2 participates in the computer game, the motion controller 230 may cause the autonomous mobile body 10 to perform a motion on the side of a character in the game opponent to the user U2. For example, the motion controller 230 causes the autonomous mobile body 10 to behave as if the autonomous mobile body 10 actually controlled the motion of this character. The above-described control allows for strongly evoking, in the user U2, a feeling as if he or she were playing the computer game against the autonomous mobile body 10, making the autonomous mobile body 10 recognized as something more familiar beyond merely a robot.

Further, for example, if the above-described character gets into an adverse situation, the motion controller 230 may cause the autonomous mobile body 10 to perform a motion that disturbs the user U2 (ramming, running around, shivering, or the like) or output a voice speech SO7 corresponding to such a motion. The above-described motion control allows for enabling a more concentrated communication with the user via the computer game.

As described above, the motion controller 230 according to the present embodiment causes the autonomous mobile body 10 to actively perform the various inducing motions related to the game, thereby making it possible to activate interactive communication between the autonomous mobile body 10 and the user.

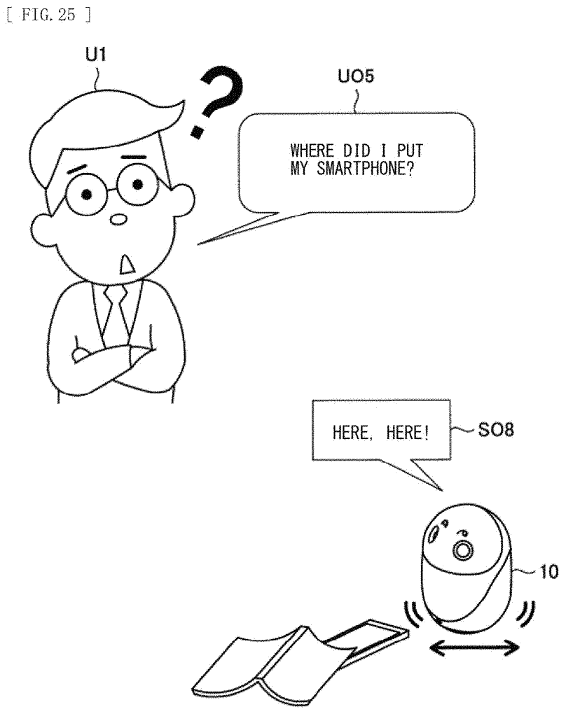

Continuously, the description on the specific examples of the inducing motions according to the present embodiment is continued. FIG. 25 is a diagram of assistance in explaining an inducing motion related to indication of an article position according to the present embodiment. FIG. 25 illustrates an example of a case where the autonomous mobile body 10 according to the present embodiment performs an inducing motion that indicates a position of a smartphone that has been looked for by a user. In this case, for example, the motion controller 230 may cause the autonomous mobile body 10 to perform, in addition to indicating a location of the smartphone by a voice speech SO8, an inducing motion such as lightly throwing itself against the smartphone, or moving back and forth or jumping around the smartphone.

As such, for example, in a case where it is presumed that the user is looking for a predetermined article on the basis of a user speech U05, the motion controller 230 according to the present embodiment is able to cause the autonomous mobile body 10 to perform a motion that indicates a position of the article. In this regard, the motion controller 230 causes the autonomous mobile body 10 to perform the inducing motion near a location where the article actually lies, thereby allowing for performing an effective information presentation to the user. It is to be noted that the recognizer 210 may, for example, detect the position of the article on the basis of image information registered in advance or detect the position on the basis of a tag attached to the article.

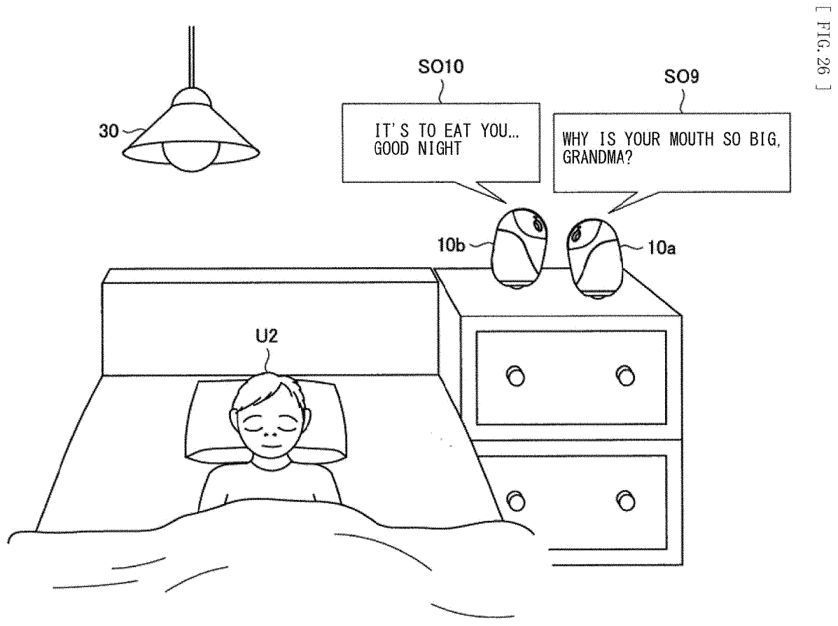

Further, FIG. 26 is a diagram of assistance in explaining an inducing motion for inviting a user to sleep according to the present embodiment. FIG. 26 illustrates an example of a case where the autonomous mobile body 10 reads the user U2 to sleep. The autonomous mobile body 10 is able to read, for example, a story registered as data in advance or various stories acquired through communication. In this regard, even in a case where a language (for example, the number of words or vocabularies) used by the autonomous mobile body 10 is usually subjected to a limitation, the motion controller 230 may cancel the limitation when causing the autonomous mobile body 10 to read.

Further, the motion controller 230 may cause the autonomous mobile body 10 to expressively reproduce voice of a character in the story or simultaneously output a sound effect, BGM, etc. Further, the motion controller 230 may cause the autonomous mobile body 10 to perform a motion that is in accordance with a line or a scene.

Further, the motion controller 230 is able to control a plurality of autonomous mobile bodies 10 to read or reproduce a story. In a case of the example of FIG. 26, the motion controller 230 causes two autonomous mobile bodies 10a and 10b to respectively play two characters in the story. As such, the motion controller 230 according to the present embodiment allows for not only simply reading the story by voice but also providing an expressive show including a physical motion to the user.

Further, the motion controller 230 according to the present embodiment may cause the autonomous mobile body 10 to perform control to turn off the operation target device 30, that is, lighting equipment, on the basis of a fact that the user has started to sleep. As such, the information processing server 20 and the autonomous mobile body 10 according to the present embodiment allow for enabling a flexible motion that is in accordance with a change in a situation related to the user or the surrounding environment.

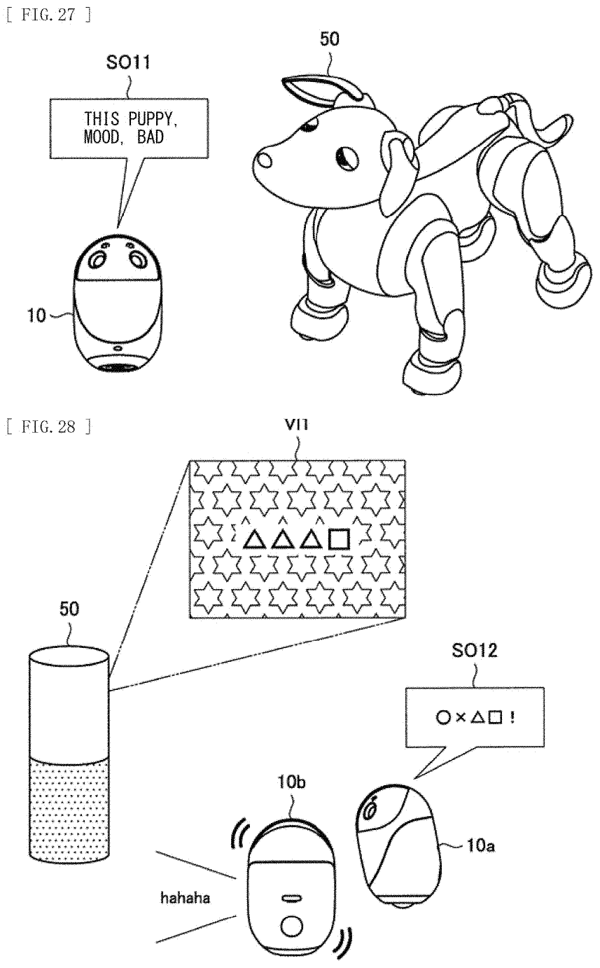

Further, the inducing motions according to the present embodiment may include communication between the autonomous mobile body 10 and another device. FIG. 27 and FIG. 28 are each a diagram of assistance in explaining communication between the autonomous mobile body 10 and another device according to the present embodiment.

FIG. 27 illustrates an example of a case where the autonomous mobile body 10 performs interpretation between another device 50, which is a dog-shaped autonomous mobile body, and a user. In this example, the motion controller 230 presents information regarding an internal state of the other device 50 to the user by a voice speech SO11. Here, the other device 50, which is the dog-shaped autonomous mobile body, may be a device without a verbal communication means.

As such, the motion controller 230 according to the present embodiment is able to present the information regarding the internal state of the other device 50 to the user via the autonomous mobile body 10. The above-described function of the motion controller 230 according to the present embodiment makes it possible to notify the user of various information regarding the other device 50, which has no means for verbal direct transfer to a user, and to activate communication between the user and the autonomous mobile body 10 or the other device 50 through this notification.

Further, FIG. 28 illustrates an example of communication between the plurality of autonomous mobile bodies 10a and 10b and the other device 50, that is, an agent device with a projection function. For example, the motion controller 230 is able to control the autonomous mobile bodies 10a and 10b and the other device 50 as if robot-to-robot communication were performed between the autonomous mobile bodies 10a and 10b and the other device 50.

In a case of the example illustrated in FIG. 28, the motion controller 230 causes the other device 50 to project visual information VII via the autonomous mobile body 10. Further, the motion controller 230 causes the autonomous mobile body 10a to output a voice speech 12 and causes the autonomous mobile body 10 to output laughter with a rocking motion of a main body thereof performed.

In this regard, the motion controller 230 may enable device-to-device communication using quasi language incomprehensible to a user. Such control causes a situation where a mysterious conversation is held between the devices to be evoked in the user, thereby making it possible to strongly attract an interest of the user. Further, for example, even in a case where the other device 50 is a display or the like with no agent function, such control causes a feeling as if a personality existed in the display to be evoked in the user, thus being expected to have an effect in enhancing an attachment of the user for the display.

It is to be noted that although the example where the motion controller 230 according to the present embodiment causes the autonomous mobile body 10 to perform the rocking motion of the main body has been given above, the motion controller 230 according to the present embodiment is able to cause the autonomous mobile body 10 to vibrate by deliberately destabilize the gyro control. Such control makes it possible to express emotions such as shivering, laughing, and fearing without the necessity of providing a separate piezoelectric element or the like.

### <<1.7. Growth Example of Autonomous Mobile Body 10>>

In the foregoing, the description has been made on the specific examples of the inducing motions to be performed by the autonomous mobile body 10 according to the present embodiment. All of the inducing motions as described above are not necessarily performable from the start but, for example, design may be made so as to gradually increase performable behaviors in accordance with a learning state of the autonomous mobile body 10. An example of a change in motion according to the learning state of the autonomous mobile body 10 according to the present embodiment, namely, growth of the autonomous mobile body 10, is given below. It is to be noted that description is made below with a case where the learning state of the autonomous mobile body 10 according to the present embodiment is defined as levels 0 to 200 taken as an example. Further, explanation is made below with the autonomous mobile body 10 treated as a subject even in a case where a main component of a process is the information processing server 20.

### (Levels 0 to 4)

The autonomous mobile body 10 is able to hear speeches of persons including a user. Further, the autonomous mobile body 10 expresses an emotion with onomatopoeia or the like instead of using words. The autonomous mobile body 10, which is able to sense a step to avoid falling, is likely to bump into an object to fall down. Further, when falling down, the autonomous mobile body 10 is not able to restore itself to an upright state. The autonomous mobile body 10 continues to perform an action until a battery runs down and an emotion thereof is unstable. The autonomous mobile body 10 frequently shivers or gets angry, blinking a lot or often changing a color of eyes.

### (Levels 5 to 9)

The autonomous mobile body 10 parrots a heard word of the user and, in response to a predetermined condition (for example, the frequency of detection) being satisfied, learns this word to repeat it. Further, the autonomous mobile body 10 comes to be able to move without bumping into an object and learns to ask for help when falling down. Further, when the battery decreases, the autonomous mobile body 10 indicates its hungriness.

### (Levels 10 to 19)

As a result of being repeatedly called by the user, the autonomous mobile body 10 understands its own name. The autonomous mobile body 10 recognizes a face or figure of the user and learns, in response to a predetermined condition (for example, the frequency of recognition) being satisfied, a name of the user. Further, the autonomous mobile body 10 ranks recognized persons and objects in terms of reliability. In this regard, an animal such as a pet, a toy, device, and the like are sometimes highly ranked in addition to the user. Further, the autonomous mobile body 10 learns to, when finding a charging station, return to the charging station by itself to be fed with power.

### (Levels 20 to 29)

The autonomous mobile body 10 comes to be able to say a short sentence (for example, “Kazuo, fine”) by combining a known word with a learned proper noun. Further, when recognizing a person, the autonomous mobile body 10 tries to approach him or her. Further, the autonomous mobile body 10 may come to be able to promptly travel.

### (Levels 30 to 49)

Expressions of question, denial, affirmative, and the like (for example, “Kazuo, how are you?”) are added to vocabularies of the autonomous mobile body 10. Further, the autonomous mobile body 10 comes to positively ask questions. For example, conversation with the user comes to continue such that “Kazuo, Lunch, Ate what?”, “Curry”, “Curry, yummy?” Further, the autonomous mobile body 10 comes to approach when the user calls it by saying “Come here” or the like and get quiet in response to “Hush” being said.

### (Levels 50 to 69)

The autonomous mobile body 10 tries to mimic a motion (for example, dance or the like) of a person or an object. Further, the autonomous mobile body 10 also tries to mimic a heard specialized sound (siren, alarm, engine sound, etc.). In this regard, the autonomous mobile body 10 may reproduce a similar sound registered as data. Further, with a cycle of time of one day learned, the autonomous mobile body 10 comes to be able to grasp a schedule of one day and notify the user (for example, “Kazuo, wake up.”, “Kazuo, How was your day?”, etc.).

### (Levels 70 to 89)

The autonomous mobile body 10 comes to be able to control an operation (for example, ON/OFF, etc.) of a registered device. Further, the autonomous mobile body 10 is also able to perform the above-described control on the basis of a request from the user. The autonomous mobile body 10 is able to output registered music in accordance with a situation. With a cycle of time of one week learned, the autonomous mobile body 10 comes to be able to grasp a weekly schedule and notify the user (for example, “Kazuo, combustible trash, taken out?”, etc.).

### (Levels 90 to 109)

The autonomous mobile body 10 learns a motion that expresses an emotion. Such an expression includes motions related to delight, anger, sorrow, and pleasure, such as loudly laughing and loudly crying. With a cycle of time of one month learned, the autonomous mobile body 10 comes to be able to grasp a monthly schedule and notify the user of the schedule (for example, “Kazuo, today, pay day!”).

### (Levels 110 to 139)

The autonomous mobile body 10 comes to laugh together when the user is laughing and come nearby and worry when he or she is crying. With a supportive response, etc. learned, the autonomous mobile body 10 acquires a variety of conversation modes such as just listening. Further, with a cycle of time of one year learned, the autonomous mobile body 10 comes to be able to grasp an annual schedule and notify the user.

### (Levels 140 to 169)

The autonomous mobile body 10 learns to restore itself from the fallen state and jump during travel. Further, the autonomous mobile body 10 is able to play “Daruma-San ga Koronda” or “Kakurenbo” with the user.

### (Levels 170 to 199)

The autonomous mobile body 10 comes to play a trick such as operating a registered device irrespective of the intention of the user. Further, the autonomous mobile body 10 comes to sulk when scolded by the user (adolescence). The autonomous mobile body 10 comes to be able to grasp a position of a registered article and notify the user of the position.

(Level 200 or above)

The autonomous mobile body 10 comes to be able to read a story. Further, the autonomous mobile body 10 is equipped with a settlement function for purchase of a product through a network, or the like.

In the foregoing, the example of the growth of the autonomous mobile body 10 according to the present embodiment has been given. It is to be noted that the above is merely an example and the motions of the autonomous mobile body 10 may be altered in accordance with the setting by the user or the like, if necessary.

### <<1.8. Flow of Control>>

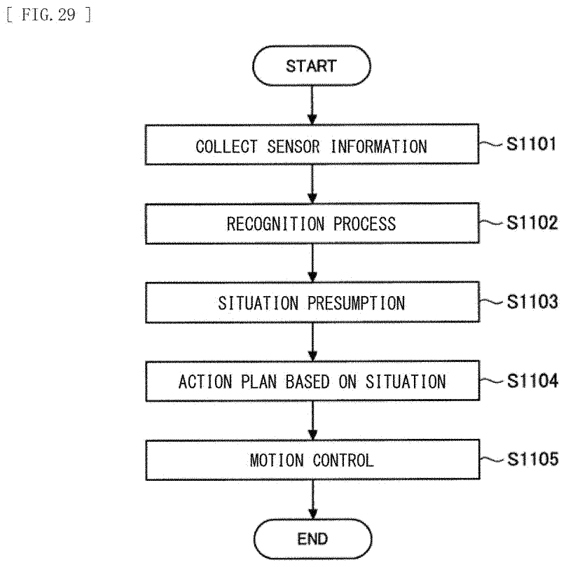

Next, detailed description is made on a flow of the control of the autonomous mobile body 10 by the information processing server 20 according to the present embodiment. FIG. 29 is a flowchart illustrating the flow of the control of the autonomous mobile body 10 by the information processing server 20 according to the present embodiment.

Referring to FIG. 29, the communicator 240 receives the sensor information from the autonomous mobile body 10 (S101).

Next, the recognizer 210 performs various recognition processes on the basis of the sensor information received in step S1101 (S1102) and presumes a situation (S1103).

Next, the action planning section 220 performs action planning based on the situation presumed in step S1103 (S1104).

Next, the motion controller 230 performs the motion control of the autonomous mobile body 10 on the basis of an action plan determined in step S1104 (S1105).

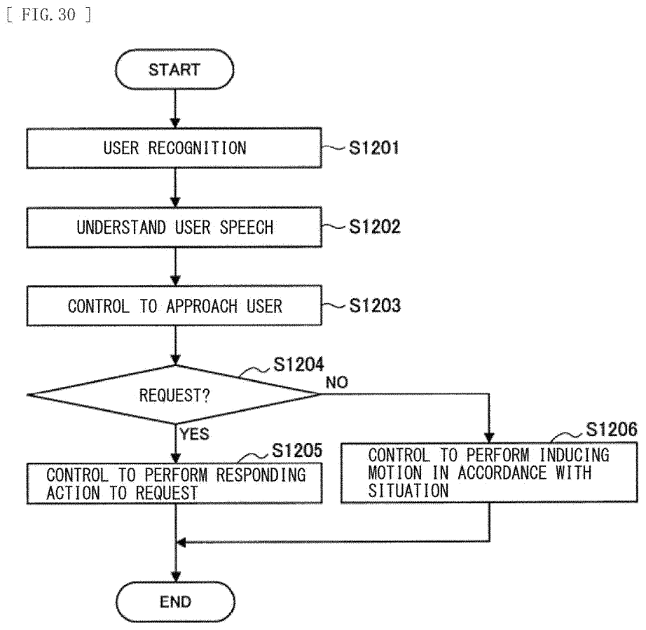

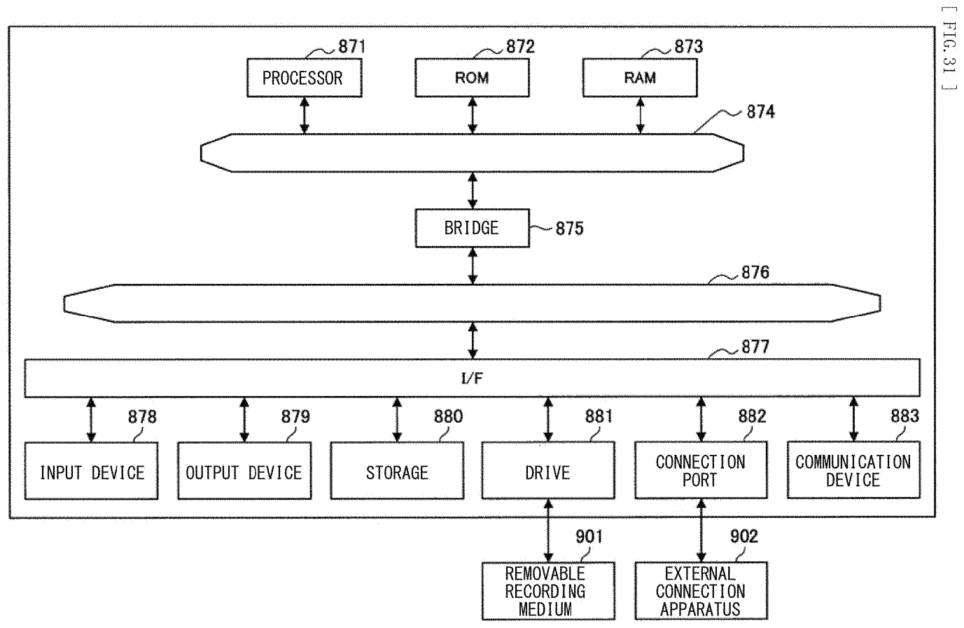

In the foregoing, the description has been made on a rough flow of the control of the autonomous mobile body 10 by the information processing server 20 according to the present embodiment. It is to be noted that the recognition process in step S1102 to the motion control in step S1105 described above may be performed repeatedly and in parallel. FIG. 30 is a flowchart illustrating an example of a flow from the recognition process to the motion control according to the present embodiment.

Referring to FIG. 30, for example, the recognizer 210 performs recognition of a user on the basis of an image captured by the autonomous mobile body 10, or the like (S1201).

Further, the recognizer 210 performs voice recognition and intention interpretation related to a speech of the user collected by the autonomous mobile body 10 to understand a speech intention of the user (S1202).

Next, the action planning section 220 plans approaching the user and the motion controller 230 controls the drive section 150 of the autonomous mobile body 10 on the basis of this plan, causing the autonomous mobile body 10 to approach the user (S1203).

Here, if the speech intention of the user understood in step S1202 is a request to the autonomous mobile body 10 or the like (S1204: YES), the motion controller 230 performs a responding action to the request on the basis of the action plan determined by the action planning section 220 (S1205). The above-described responding action includes, for example, presentation of a reply to an inquiry from the user, control of the operation target device 30, etc.

Meanwhile, if the speech intention of the user understood in step S1202 is not a request to the autonomous mobile body 10 (S1204: NO), the motion controller 230 causes the autonomous mobile body 10 to perform various inducing motions in accordance with the situation on the basis of the action plan determined by the action planning section 220 (S1206).

### 2. Hardware Configuration Example

Next, description is made on a hardware configuration example of the information processing server 20 according to one embodiment of the present disclosure. FIG. 31 is a block diagram illustrating the hardware configuration example of the information processing server 20 according to one embodiment of the present disclosure. Referring to FIG. 31, the information processing server 20 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. It is to be noted that the hardware configuration described herein is merely an example and a part of the components may be omitted. Further, a component other than the components described herein may be further included.

### (Processor 871)

The processor 871, which functions as, for example, an arithmetic processor or a control device, controls all or a part of the motions of the components on the basis of a variety of programs recorded in the ROM 872, the RAM 873, the storage 880, or a removable recording medium 901.

### (ROM 872, RAM 873)

The ROM 872 is a means for storing a program to be read by the processor 871, data for use in calculation, etc. The RAM 873 temporarily or permanently stores, for example, a program to be read by the processor 871, a variety of parameters to be varied if necessary in executing the program, etc.

### (Host Bus 874, Bridge 875, External Bus 876, Interface 877)

The processor 871, the ROM 872, and the RAM 873 are mutually coupled through, for example, the host bus 874 that enables a high-speed data transfer. Meanwhile, the host bus 874 is coupled to, for example, the external bus 876, a data transfer speed of which is relatively low, through the bridge 875. Further, the external bus 876 is coupled to various components through the interface 877.

### (Input Device 878)

For example, a mouse, a keyboard, a touch panel, a button, a switch, a lever, etc. are usable as the input device 878. Further, a remote controller (hereinafter, remocon) able to send a control signal using infrared light or any other electric wave is usable as the input device 878 in some cases. Further, the input device 878 includes a voice input device such as a microphone.

### (Output Device 879)

The output device 879 is a device able to visually or audially notify a user of acquired information, which is, for example, a display such as a CRT (Cathode Ray Tube), an LCD, or an organic EL, an audio output device such as a speaker or a headphone, a printer, a mobile phone, a facsimile machine, or the like. Further, the output device 879 according to the present disclosure includes various vibration devices that are able to output tactile stimuli.

### (Storage 880)

The storage 880 is a device for storing a variety of data. For example, a magnetic storage device such as a hard disk drive (HDD), a semiconductor storage device, an optical storage device, a magneto-optical storage device, and the like are usable as the storage 880.

### (Drive 881)

The drive 881 is, for example, a device that reads information recorded in the removable recording medium 901 such as a magnetic disk, an optical disk, a magneto-optical disk or a semiconductor memory, or writes information in the removable recording medium 901.

### (Removable Recording Medium 901)

The removable recording medium 901 is, for example, a DVD medium, a Blu-ray (registered trademark) medium, an HD DVD medium, a variety of semiconductor storage media, or the like. Of course, the removable recording medium 901 may be, for example, an IC card equipped with a contactless IC chip or an electronic apparatus or the like.

### (Connection Port 882)

The connection port 882 is, for example, a port for coupling an external connection apparatus 902 such as a USB (Universal Serial Bus) port, an IEEE 1394 port, an SCSI (Small Computer System Interface), an RS-232C port, or an optical audio terminal.

### (External Connection Apparatus 902)

The external connection apparatus 902 is, for example, a printer, a portable music player, a digital camera, a digital video camera, an IC recorder, or the like.

### (Communication Device 883)

The communication device 883, that is, a communication device for coupling to a network, is, for example, a communication card for a wired or wireless LAN, Bluetooth (registered trademark), or a WUSB (Wireless USB), an optical communication router, an ADSL (Asymmetric Digital Subscriber Line) router, a variety of communication modems, or the like.

### 3. Summary

The information processing server 20 according to one embodiment of the present disclosure includes the motion controller 230 that controls the motion of the autonomous mobile body 10 as described above. Further, one of the features of the motion controller 230 according to one embodiment of the present disclosure is causing the autonomous mobile body to actively perform the inducing motions that induce communication between a user and the autonomous mobile body 10. Further, such inducing motions and communication include at least a behavior of the autonomous mobile body 10 in a physical space. Such a configuration more naturally and effectively enables communication with the user.

Although the detailed description has been made above on the preferred embodiment of the present disclosure with reference to the attached drawings, the technical scope of the present disclosure is not limited to such an example. It is obvious that a variety of alterations and modifications within the scope of the technical idea according to the claims would occur to those having ordinary knowledge in the art to which the present disclosure pertains and it is, of course, understood that these also belong to the technical scope of the present disclosure.

In addition, the effects described herein are merely explanatory and illustrative and not limitative. That is, the technology according to the present disclosure may exhibit other effects obvious to those skilled in the art from the description herein in addition to the above-described effects or instead of the above-described effects.

In addition, the steps of the process of the information processing server 20 herein are not necessarily performed in time series along the order indicated in the flowchart. For example, the steps of the process of the information processing server 20 may be performed in an order different from the order indicated in the flowchart or performed in parallel.

It is to be noted that the following configurations also belong to the technical scope of the present disclosure.

(1)

An information processor including a motion controller that controls a motion of an autonomous mobile body,

the motion controller causing the autonomous mobile body to perform a transfer motion in a state in which the autonomous mobile body maintains a forward-tilting attitude,

the transfer motion including at least any one of a forward and backward movement, a turning movement, or a rotary movement.

(2)

The information processor according to (1), in which

the motion controller controls the transfer motion to cause a center of gravity of the autonomous mobile body to be positioned on a vertical line with respect to a rotation axis of a wheel of the autonomous mobile body during maintaining the forward-tilting attitude, and

a weight component for keeping balance during maintaining the forward-tilting attitude is disposed on a back side of the autonomous mobile body.

(3)

The information processor according to (1) or (2), in which

the motion controller causes the autonomous mobile body to actively perform an inducing motion that induces communication between a user and the autonomous mobile body, and

the inducing motion and the communication include at least a behavior of the autonomous mobile body in a physical space.

(4)

The information processor according to (3), in which the inducing motion includes a motion for causing the user to perform a predetermined action.

(5)

The information processor according to (3) or (4), in which the inducing motion includes a motion for causing the user to perform a collaborative action with the autonomous mobile body.

(6)

The information processor according to (5), in which the collaborative action includes a game played by the user and the autonomous mobile body.

(7)

The information processor according to (6), in which the game necessitates a physical motion of each of the user and the autonomous mobile body.

(8)

The information processor according to (6) or (7), in which the game uses a language.

(9)

The information processor according to any one of (6) to (8), in which the game includes a computer game.

(10)

The information processor according to any one of (6) to (9), in which the motion controller causes the autonomous mobile body to perform an inducing motion related to the game in which of words and actions of the user.

(11)

The information processor according to any one of (3) to (10), in which the inducing motion includes a motion that indicates a position of an article to the user.

(12)

The information processor according to (11), in which the motion controller causes the autonomous mobile body to perform the motion that indicates the position of the article if it is presumed that the user is looking for the article.

(13)

The information processor according to any one of (3) to (12), in which the inducing motion includes a motion that is not intended by the user or does not match an intention.

(14)

The information processor according to any one of (3) to (13), in which the inducing motion includes an operation of a device irrespective of an intention of the user.

(15)

The information processor according to any one of (3) to (14), in which the inducing motion includes a motion that encourages the user to start or continue a speech.

(16)

The information processor according to any one of (3) to (15), in which the inducing motion includes communication between the autonomous mobile body and another device.

(17)

The information processor according to any one of (3) to (16), in which the inducing motion includes a motion for inviting the user to sleep.

(18)

The information processor according to (17), in which the motion controller causes the autonomous mobile body to turn off lighting equipment on a basis of a fact that the user has started to sleep.

(19)

The information processor according to any one of (3) to (18), in which the inducing motion includes inducement to the communication by voice.

(20)

The information processor according to any one of (1) to (19) including the autonomous mobile body.

(21)

An information processing method including controlling a motion of an autonomous mobile body by a processor,

the controlling including causing the autonomous mobile body to perform a transfer motion in a state in which the autonomous mobile body maintains a forward-tilting attitude,

the transfer motion including at least any one of a forward and backward movement, a turning movement, or a rotary movement.

(22)

A program for causing a computer to function as an information processor, the information processor including a motion controller that controls a motion of an autonomous mobile body,

the motion controller causing the autonomous mobile body to perform a transfer motion in a state in which the autonomous mobile body maintains a forward-tilting attitude,

the transfer motion including at least any one of a forward and backward movement, a turning movement, or a rotary movement.

### REFERENCE SIGNS LIST

10 autonomous mobile body
110 sensor section
120 input section
130 light source
140 voice output section
150 drive section
160 controller
170 communicator
information processing server
210 recognizer
220 action planning section
230 motion controller
240 communicator
30 operation target device

1. An information processor comprising a motion controller that controls a motion of an autonomous mobile body,
the motion controller causing the autonomous mobile body to perform a transfer motion in a state in which the autonomous mobile body maintains a forward-tilting attitude,
the transfer motion including at least any one of a forward and backward movement, a turning movement, or a rotary movement.

2. The information processor according to claim 1, wherein
the motion controller controls the transfer motion to cause a center of gravity of the autonomous mobile body to be positioned on a vertical line with respect to a rotation axis of a wheel of the autonomous mobile body during maintaining the forward-tilting attitude, and
a weight component for keeping balance during maintaining the forward-tilting attitude is disposed on a back side of the autonomous mobile body.

3. The information processor according to claim 1, wherein
the motion controller causes the autonomous mobile body to actively perform an inducing motion that induces communication between a user and the autonomous mobile body, and
the inducing motion and the communication include at least a behavior of the autonomous mobile body in a physical space.

4. The information processor according to claim 3, wherein the inducing motion includes a motion for causing the user to perform a predetermined action.

5. The information processor according to claim 3, wherein the inducing motion includes a motion for causing the user to perform a collaborative action with the autonomous mobile body.

6. The information processor according to claim 5, wherein the collaborative action includes a game played by the user and the autonomous mobile body.

7. The information processor according to claim 6, wherein the game necessitates a physical motion of each of the user and the autonomous mobile body.

8. The information processor according to claim 6, wherein the game uses a language.

9. The information processor according to claim 6, wherein the game includes a computer game.

10. The information processor according to claim 6, wherein the motion controller causes the autonomous mobile body to perform an inducing motion related to the game on a basis of words and actions of the user.

11. The information processor according to claim 3, wherein the inducing motion includes a motion that indicates a position of an article to the user.

12. The information processor according to claim 11, wherein the motion controller causes the autonomous mobile body to perform the motion that indicates the position of the article if it is presumed that the user is looking for the article.

13. The information processor according to claim 3, wherein the inducing motion includes a motion that is not intended by the user or does not match an intention.

14. The information processor according to claim 3, wherein the inducing motion includes an operation of a device irrespective of an intention of the user.

15. The information processor according to claim 3, wherein the inducing motion includes a motion that encourages the user to start or continue a speech.

16. The information processor according to claim 3, wherein the inducing motion includes communication between the autonomous mobile body and another device.

17. The information processor according to claim 3, wherein the inducing motion includes a motion for inviting the user to sleep.

18. The information processor according to claim 17, wherein the motion controller causes the autonomous mobile body to turn off lighting equipment on a basis of a fact that the user has started to sleep.

19. An information processing method comprising controlling a motion of an autonomous mobile body by a processor,
the controlling including causing the autonomous mobile body to perform a transfer motion in a state in which the autonomous mobile body maintains a forward-tilting attitude,
the transfer motion including at least any one of a forward and backward movement, a turning movement, or a rotary movement.

20. A program for causing a computer to function as an information processor, the information processor including a motion controller that controls a motion of an autonomous mobile body,
the motion controller causing the autonomous mobile body to perform a transfer motion in a state in which the autonomous mobile body maintains a forward-tilting attitude,
the transfer motion including at least any one of a forward and backward movement, a turning movement, or a rotary movement.
